(19) United States
(12) Patent Application Publication
(10) Pub. No.: US 2006/0292420 A1
(43) Pub. Date: Dec. 28, 2006

(54) Fuel cell device

(75) Inventors: Motoi Goto, Tachikawa-shi (JP); Tomohiro Hirayama, Oume-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/368,984

(22) Filed: Mar. 6, 2006

(30) Foreign Application Priority Data
Jun. 22, 2005 (JP) P2005-181491

(51) Int. Cl. H01M 8/02; H01M 8/04

(52) U.S. Cl. 429/34; 429/38

(57) ABSTRACT

A fuel cell device includes: a device body; a fuel cell that is housed in the device body; a user accessible compartment that is disposed in the device body and covered by a detachable cover; an auxiliary unit that is disposed in the user accessible compartment; an air intake port that is disposed in the user accessible compartment draws in air to be used in electricity generation by the fuel cell; and a detachable air intake filter that covers the air intake port.

### CROSS-REFERENCE TO RELATED APPLICATIONS

This application is based upon and claims the benefit of priority from Japanese Patent Application No. 2005-181491, filed on Jun. 22, 2005, the entire contents of which are incorporated herein by reference.

### BACKGROUND

1. Field

One embodiment relates to a direct methanol fuel cell device in which, for example, methanol and the air are supplied to a fuel cell with using a fuel pump and an air feed pump, and more particularly to a structure of an air intake system which draws in the air to be used in electricity generation.

2. Description of the Related Art

Recently, as a power source for an electronic apparatus such as a portable computer, a compact fuel cell device which produces a high power output, and which does not require a charging operation attract attention. Among fuel cell devices of this kind, for example, a direct methanol fuel cell device (hereinafter, abbreviated to DMFC) in which a methanol aqueous solution is circulated is preferable as a power source for an electronic apparatus because the fuel can be easily handled and the whole system is simple as compared with a fuel cell device which uses hydrogen as a fuel.

A conventional DMFC includes: a DMFC stack having a fuel electrode, an air electrode, and an electrolyte film; a fuel supply path thorough which a methanol aqueous solution is supplied to the fuel electrode of the DMFC stack, and an air supply path which supplies the air to the air electrode of the DMFC stack. The air supply path has an air intake port through which the air to be used in electricity generation is drawn in from the atmosphere.

In the fuel electrode of the DMFC stack, methanol reacts with water to be oxidized, and carbon dioxide, hydrogen ions, and electrons are produced. The produced hydrogen ions pass through the electrolyte film, and reach the air electrode. In the air electrode, oxygen in the air is coupled with the hydrogen ions and electrons to be reduced, and water is produced. At this time, electrons flow through an external circuit connected between the fuel electrode and the air electrode, whereby the electricity generating operation is conducted.

When the air supplied to the DMFC stack contains, for example, a hydrocarbon compound, the compound adheres to the air electrode, thereby causing the reduction reaction on the air electrode to be inhibited. Particularly, the reduction reaction inhibition leads to degradation of the electricity generation performance of the DMFC. When oxygen for the reduction reaction is taken in from the air, therefore, hydrocarbon compounds must be promptly removed away from the air.

In a conventional DMFC, therefore, an air intake filter is disposed in an air supply path extending from an air intake port to an air electrode. The air intake filter purifies the air drawn in from the air intake port, and has a function of adsorbing hydrocarbon compounds contained in the air (for example, see JP-A-2001-185193, a corresponding U.S. patent publication of which is US2004/0023094A1).

In order to keep the original electricity generation performance of a DMFC, it is important to maintain the purification performance of an air intake filter to a high level. Therefore, it is preferable to frequently replace the air intake filter with a new one in order to prevent the purification performance from deteriorating.

In the configuration disclosed in JP-A-2001-185193, an air intake filter for purifying the air is provided. However, the document discloses no suggestion of a measure for frequent replacement of an air intake filter, and fails to disclose a specific configuration for maintaining the purification performance of the air intake filter.

Furthermore, the device of JP-A-2001-185193 requires a mechanism that supplies water to the air intake filter in order to hold the air intake filter to a wet condition. Therefore, it is inevitable that the configuration of the air intake filter is complicated, or that the air intake filter is located in an inner position of the fuel cell device.

In order to replace the air intake filter with a new filter, consequently, the whole device must be disassembled to take out the air intake filter. The conventional device has a disadvantage that operations of replacing and attaching or detaching the air intake filter require a large amount of labor and trouble.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of a fuel cell device according to an embodiment;

FIG. 2 is a perspective view showing a state where a portable computer is connected to the fuel cell device of the embodiment;

FIG. 3 is a perspective view showing positional relationships among a fuel cartridge, a mixing tank, an air feed pump, a DMFC stack, and first and second condensers in the embodiment;

FIG. 4 is a perspective view showing a positional relationship between an air intake filter and a holder in the embodiment;

FIG. 5 is a side view showing the positional relationship between the air intake filter and the holder in the embodiment;

FIG. 6 is a section view showing positional relationships among the air intake filter, the holder, the fuel cartridge, and an air supply pipe in the embodiment;

FIG. 7 is a section view showing a state where the fuel cartridge and a cover are removed from the holder to expose the air intake filter in the embodiment;

FIG. 8 is a perspective view showing a positional relationship between the first and second condensers in the embodiment;

FIG. 9 is a side view showing the positional relationship between the first and second condensers in the embodiment;

FIG. 10 is a block diagram of the fuel cell device of the embodiment; and

FIG. 11 is a section view of the fuel cell device of the embodiment.

### DETAILED DESCRIPTION

Various embodiments according to the invention will be described hereinafter with reference to the accompanying drawings.

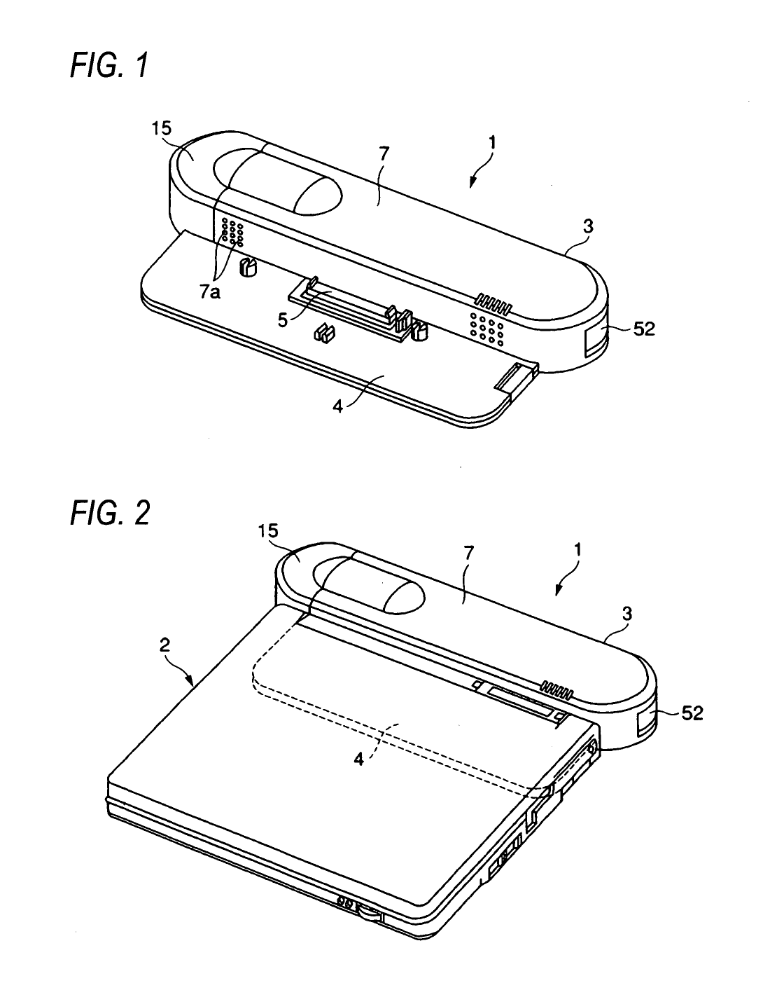

FIGS. 1 and 2 show an active type DMFC 1 that uses, for example, methanol as a fuel. The DMFC 1 has a size that can be used as a power source of, for example, a portable computer 2.

The DMFC 1 has a device body 3 and a mounting portion 4. The device body 3 is formed into a elongated box-like shape which elongates in the width direction of the portable computer 2. The mounting portion 4 horizontally projects from the front end of the device body 3 so that a rear end portion of the portable computer 2 can be mounted on the mounting portion. A power source connector 5 is placed on the upper face of the mounting portion 4. When the portable computer 2 is mounted on the mounting portion 4, the power source connector 5 is electrically connected to the portable computer 2.

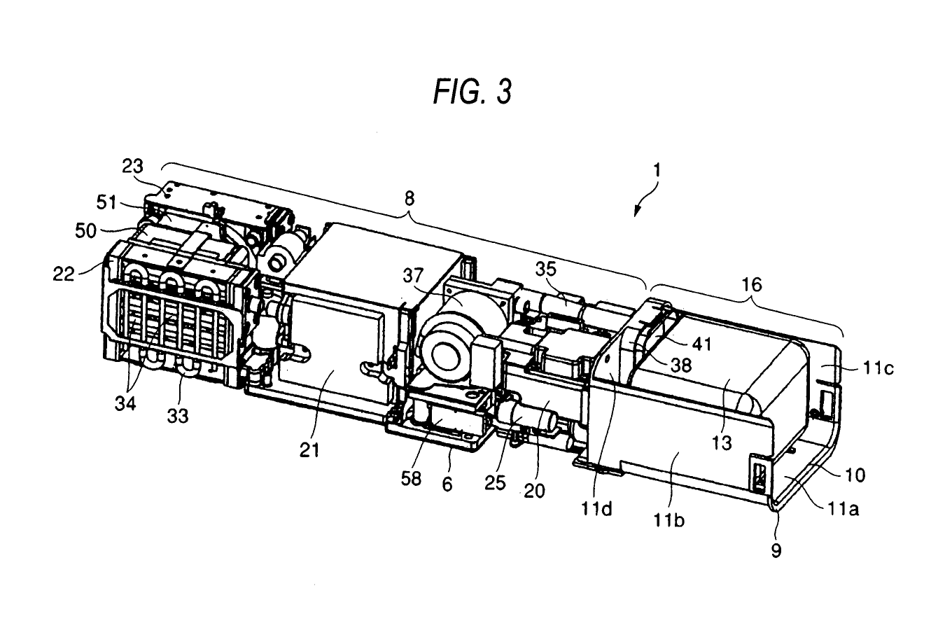

The device body 3 has a base 6 shown FIGS. 3 to 7, and a top cover 7 which covers the base 6. The base 6 and the top cover 7 cooperate with each other to define a hollow closed compartment 8. The closed compartment 8 is a section where the user using the DMFC 1 is basically prohibited from accessing the section, and occupies a major portion of the device body 3.

The base 6 has a holder support portion 9. The holder support portion 9 is positioned in one end in the longitudinal direction of the device body 3, and projects to the outside of the closed compartment 8 without being covered by the top cover 7. A holder 10 is attached onto the holder support portion 9. The holder 10 has a bottom wall 11a, a pair of side walls 11b, 11c, and a partition wall 11d. The bottom wall 11a is placed on the holder support portion 9. The side walls 11b, 11c are opposed to each other with forming a gap therebetween in the width direction of the device body 3. The partition wall 11d stands on the bottom wall 11a so as partition between the closed compartment 8 and the holder 10.

As shown in FIG. 3, the holder 10 detachably supports a fuel cartridge 13. The fuel cartridge 13 is an example of an auxiliary unit that serves for the fuel cell. As a fuel to be used in electricity generation, for example, high-concentration methanol is stored in the fuel cartridge 13. The fuel cartridge 13 is formed into a hollow box-like shape, and has a fuel supply port 14 in one end face. When the fuel cartridge 13 is emptied, the fuel cartridge is detached from the holder 10, and a new fuel cartridge 13 is attached to the holder 10. In other words, the fuel cartridge 13 is replaceably supported by the holder 10.

The fuel cartridge 13 is covered by a cover 15. The cover 15 is detachably supported by the holder 10 so as to be continuous with the top cover 7. The cover 15 cooperates with the holder 10 to define a hollow accessible compartment 16. The accessible compartment 16 is an example of a user accessible compartment where the user can basically freely access the region, and partitioned from the closed compartment 8 by the partition wall 11d. The fuel cartridge 13 is housed in the accessible compartment 16.

When the fuel cartridge 13 is to be replaced, the cover 15 is detached from the holder 10. In a state where the cover 15 is detached, the fuel cartridge 13 and the holder 10 are exposed to the outside of the device body 3.

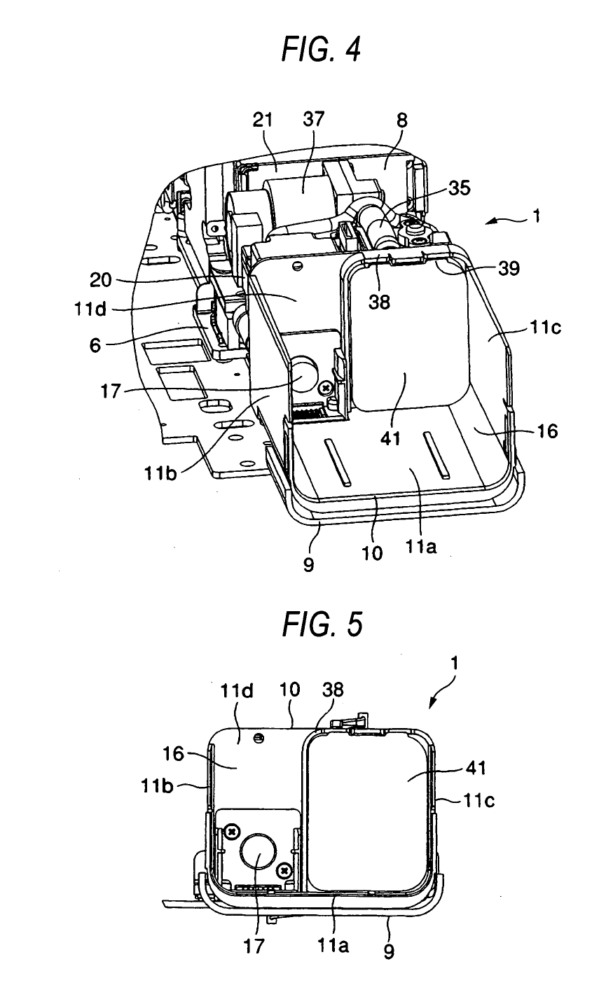

As shown in FIGS. 4 and 5, the partition wall 11d of the holder 10 has a cartridge connection port 17. The cartridge connection port 17 is exposed in the accessible compartment 16. When the fuel cartridge 13 is attached to the holder 10, the fuel supply port 14 of the fuel cartridge 13 is connected to the cartridge connection port 17.

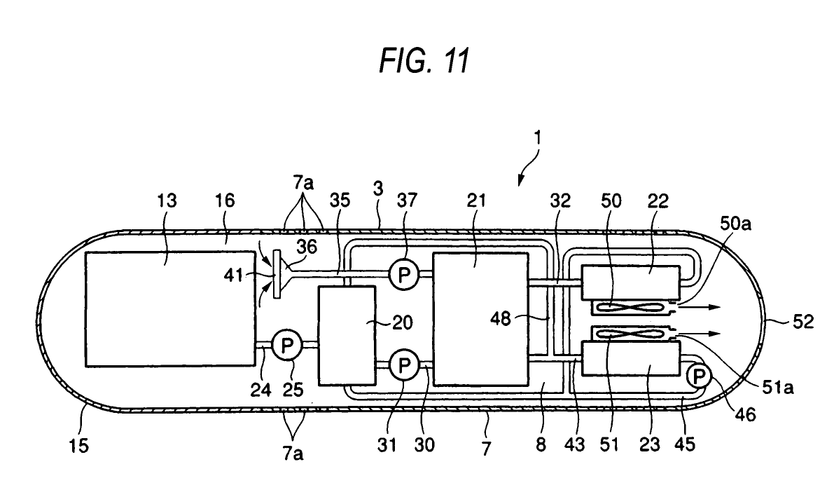

As shown in FIGS. 3 and 11, a mixing tank 20, a DMFC stack 21, a first condenser 22, and a second condenser 23 are housed in the closed compartment 8 of the device body 3.

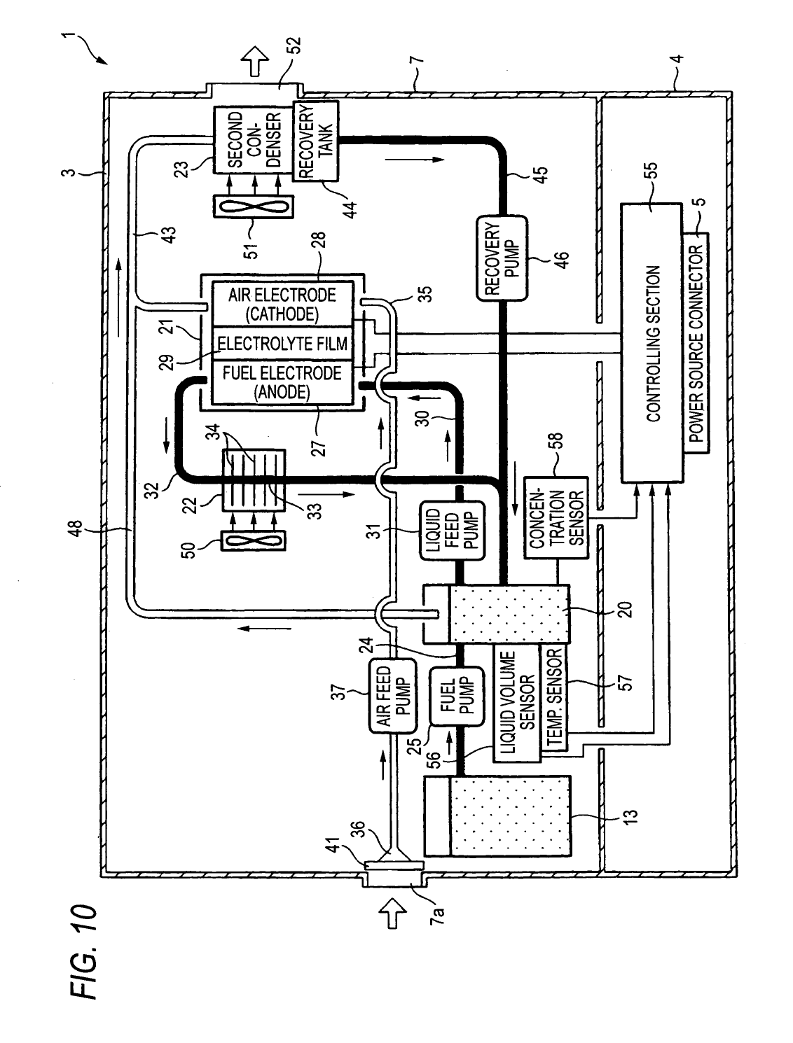

The mixing tank 20 dilutes the high-concentration methanol to produce a methanol aqueous solution having a concentration of, for example, several to several tens percent. The mixing tank 20 is supported by the base 6, and adjacent to the fuel cartridge 13 with the partition wall 11d therebetween. As shown FIG. 10, the mixing tank 20 is connected to the cartridge connection port 17 via a first fuel supply pipe 24. The first fuel supply pipe 24 has a fuel pump 25 which feeds the high-concentration methanol to the mixing tank 20.

The DMFC stack 21 is an example of a fuel cell which generates electricity with using a chemical reaction of methanol. The DMFC stack 21 has a fuel electrode (anode) 27, an air electrode (cathode) 28, and an electrolyte film 29 which is interposed between the electrodes 27, 28. The DMFC stack 21 is supported by the base 6, and positioned in a middle portion in the longitudinal direction of the device body 3.

The fuel electrode 27 of the DMFC stack 21 is connected to the mixing tank 20 via a second fuel supply pipe 30. The second fuel supply pipe 30 is connected to one end of the fuel electrode 27, and has a liquid feed pump 31 which feeds the methanol aqueous solution in the mixing tank 20 to the fuel electrode 27.

The other end of the fuel electrode 27 is connected to the mixing tank 20 via a fuel return pipe 32. The fuel return pipe 32 is used for returning unreacted methanol aqueous solution discharged from the fuel electrode 27, and carbon dioxide which is produced by oxidation reaction in the fuel electrode 27, to the mixing tank 20. The unreacted methanol aqueous solution and the carbon dioxide are examples of materials which are discharged from the fuel electrode 27. Immediately after being discharged from the fuel electrode 27, the temperature of the methanol aqueous solution is 60° C. or higher because it is affected by heat generated in the electricity generating operation of the DMFC stack 21.

The first condenser 22 is in the middle of the fuel return pipe 32. The first condenser 22 cools the methanol aqueous solution which is returned from the fuel electrode 27 to the mixing tank 20. The first condenser 22 has a pipe 33 through which the methanol aqueous solution flows, and a plurality of radiation fins 34 which are thermally coupled to the pipe 33.

As shown in FIG. 10, an air supply pipe 35 is connected to one end of the air electrode 28 of the DMFC stack 21. The air supply pipe 35 is housed in the closed compartment 8, and linearly elongates from the DMFC stack 21 toward the partition wall 11d of the holder 10.

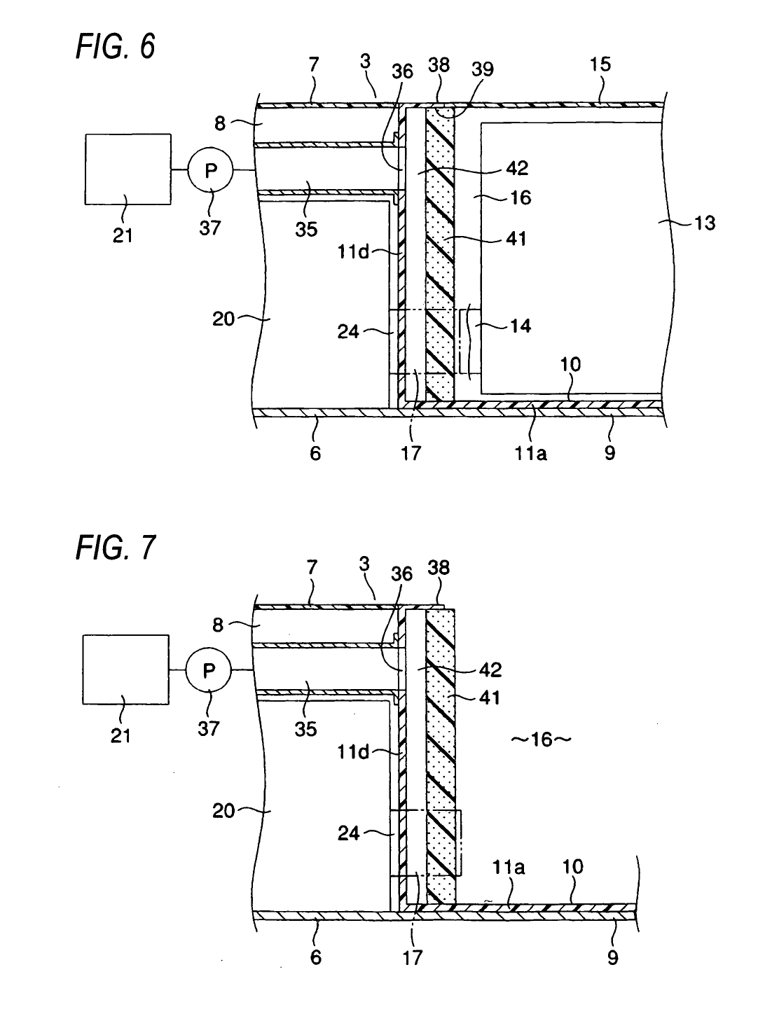

As shown in FIGS. 6 and 7, the partition wall 11d has an air intake port 36. The air intake port 36 draws in the air to be used in electricity generation, from the atmosphere, and opened toward the accessible compartment 16. Therefore, the air intake port 36 is positioned in one end portion in the longitudinal direction of the device body 3. The air supply pipe 35 which elongates from the DMFC stack 21 is connected to the air intake port 36. The top cover 7 of the device body 3 has a plurality of ventilation holes 7a in positions corresponding to the air intake port 36.

The air supply pipe 35 has an air feed pump 37. The air feed pump 37 feeds the air drawn in from the air intake port 36 to the air electrode 28 of the DMFC stack 21. The air feed pump 37 is located between the DMFC stack 21 and the air intake port 36.

As shown FIGS. 4 to 7, a rib-like filter support wall 38 is formed on the partition wall 11d of the holder 10. The filter support wall 38 protrudes from the partition wall 11d toward the interior of the holder 10 so as to surround the air intake port 36. The filter support wall 38 cooperates with the bottom wall 11a and one side wall 11c of the holder 10 to define a square filter attachment port 39.

An air intake filter 41 is attached to the filter attachment port 39. The air intake filter 41 is formed into a square plate-like shape having a constant thickness, and has a function of adsorbing hydrocarbon compounds contained in, for example, the air. The air intake filter 41 is detachably fitted into the filter attachment port 39 in the direction from the side of the holder 10. According to the configuration, the outer peripheral face of the air intake filter 41 is in airtight contact with the filter support wall 38, the bottom wall 11a, and the side wall 11c to cover the air intake port 36 in the direction from the side of the holder 10. Therefore, the air intake filter 41 is interposed in a gap portion between the fuel cartridge 13 and the partition wall 11d, and exposed in the accessible compartment 16.

In other words, the air intake filter 41 stands so as to extend along the partition wall 11d, and is opposed to one end face of the fuel cartridge 13. As a result, the air intake filter 41 can be enlarged in size, and a sufficient contact area with the air can be ensured.

As shown in FIGS. 6 and 7, a clean space 42 which is hermetically sealed is formed between the air intake filter 41 and the partition wall 11d of the holder 10. The air intake port 36 is opened in the clean space 42. When the air feed pump 37 is driven, therefore, the air is drawn in from the clean space 42 through the air intake port 36.

The air intake filter 41 is positioned on the extension of the air supply pipe 35. The air intake filter 41 and the air feed pump 37 are aligned so as to maintain the linear positional relationship.

As shown in FIG. 10, the second condenser 23 is connected to the other end of the air electrode 28 via an exhaust pipe 43. The second condenser 23 cools materials discharged from the air electrode 28, such as water vapor and water, and is connected to the downstream end of the exhaust pipe 43. The second condenser 23 has a recovery tank 44. The recovery tank 44 stores water discharged from the air electrode 28, and that recovered from water vapor. The gas component from which water is separated in the second condenser 23 is discharged to the atmosphere from the second condenser 23.

The recovery tank 44 is connected to the fuel return pipe 32 via a recovery pipe 45. The recovery pipe 45 has a recovery pump 46 which feeds water stored in the recovery tank 44 to the mixing tank 20 via the fuel return pipe 32.

The exhaust pipe 43 has a branch pipe 48 which branches off from a portion between the air electrode 28 and the second condenser 23. The upstream end of the branch pipe 48 is connected to the mixing tank 20. The branch pipe 48 is used for guiding the carbon dioxide returned to the mixing tank 20, to the second condenser 23 via the exhaust pipe 43. The carbon dioxide guided to the second condenser 23 is discharged to the atmosphere from the second condenser 23.

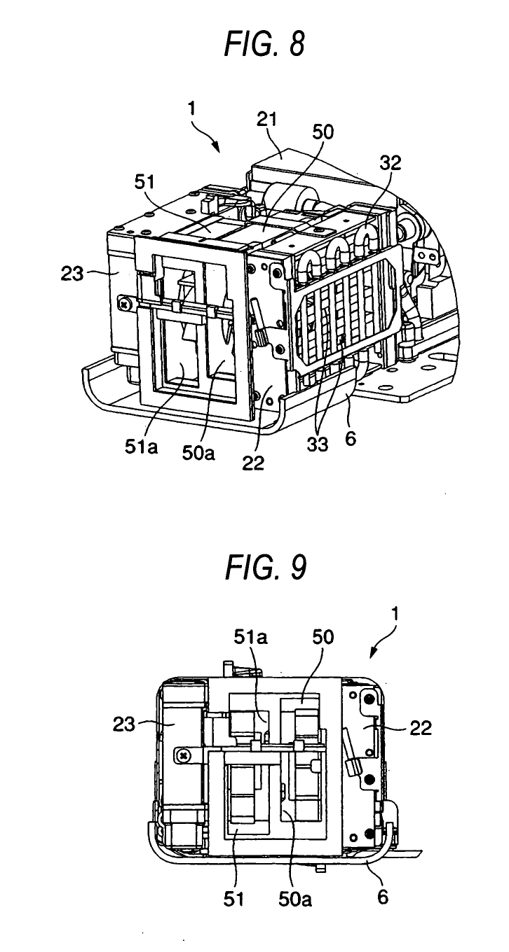

As shown in FIGS. 3 and 8, the first condenser 22 and the second condenser 23 are disposed in the other end portion of the device body 3, and positioned in the opposite side with respect to the fuel cartridge 13 while interposing the mixing tank 20 and the DMFC stack 21 therebetween. The first and second condensers 22, 23 are supported by the base 6 so as to be opposed to each other across a space, and first and second fans 50, 51 are disposed between the condensers 22, 23.

In the embodiment, therefore, the fuel cartridge 13, the mixing tank 20, the air feed pump 37, the DMFC stack 21, and the first and second condensers 22, 23 are aligned in a row in the longitudinal direction of the device body 3.

The first fan 50 is overlaid on the first condenser 22. When the first fan 50 operates, a flow of cooling air which passes through the first condenser 22 toward the first fan 50 is formed, and the first condenser 22 is cooled by the cooling air. The cooling air which has cooled the first condenser 22 is blown out through a discharge port 50a of the first fan 50.

The second fan 51 is overlaid on the second condenser 23. When the second fan 51 operates, a flow of cooling air which passes through the second condenser 23 toward the second fan 51 is formed, and the second condenser 23 is cooled by the cooling air. The cooling air which has cooled the second condenser 23 is blown out from a discharge port 51a of the second fan 51. Also impurities discharged from the second condenser 23, such as carbon dioxide are blown out from the discharge port 51a by the flow of cooling air.

As shown in FIGS. 8 and 11, the discharge ports 50a, 51a of the first and second fans 50, 51 are opened so as to be directed toward the other end of the device body 3. The device body 3 has an exhaust port 52 in the other end. The exhaust port 52 is formed in the top cover 7 of the device body 3, and opposed to the discharge ports 50a, 51a of the first and second fans 50, 51. Therefore, the cooling air and impurities such as carbon dioxide blown out from the discharge ports 50a, 51a are discharged to the outside of the device body 3 through the exhaust port 52.

The opening direction of the exhaust port 52 is opposite to that of the air intake port 36. In other words, the air intake port 36 through which the air for electricity generation is drawn in is opened in a direction different from that of the exhaust port 52, in a position which is remote from the exhaust port 52 in the longitudinal direction of the device body 3. Even when a gas in which the concentration of oxygen that is required in electricity generation is low, and which contains impurities such as carbon dioxide is discharged from the exhaust port 52, therefore, the air intake port 36 hardly draws in the gas discharged from the exhaust port 52.

As shown in FIG. 10, the DMFC 1 has a controlling section 55. The controlling section 55 controls, for example, the concentration and quantity of the methanol aqueous solution produced in the mixing tank 20, and exchanges information with the portable computer 2, thereby controlling the power to be supplied to the portable computer 2. The controlling section 55 is housed in the mounting portion 4 of the DMFC 1, and electrically connected to the power source connector 5 and the DMFC stack 21.

The controlling section 55 controls the quantities of the high-concentration methanol which is supplied from the fuel cartridge 13 to the mixing tank 20, the unreacted methanol aqueous solution which is returned from the fuel electrode 27 of the DMFC stack 21, and the water which is returned from the air electrode 28 of the DMFC stack 21, thereby adjusting the concentration of the methanol aqueous solution.

Specifically, the mixing tank 20 includes: a liquid volume sensor 56 which detects the quantity of the methanol aqueous solution in the tank; a temperature sensor 57 which detects the temperature of the methanol aqueous solution; and a concentration sensor 58 which detects the concentration of the methanol aqueous solution. Data which are detected by the sensors 56, 57, 58, and which relate to the methanol aqueous solution are sent to the controlling section 55. Based on the data from the sensors 56, 57, 58, the controlling section 55 controls the fuel pump 25, the recovery pump 46, and the like. According to the configuration, the quantity of the high-concentration methanol which flows from the fuel cartridge 13 into the mixing tank 20, and that of water which flows from the recovery tank 44 into the mixing tank 20 are adjusted so that the concentration of the methanol aqueous solution is controlled to a value by which the performance of electricity generation is satisfactorily maintained.

Next, the electricity generating operation of the DMFC 1 will be described.

The high-concentration methanol stored in the fuel cartridge 13 is fed by the fuel pump 25 to the mixing tank 20. Water which is recovered from the air electrode 28 of the DMFC stack 21, and the unreacted low-concentration methanol which is discharged from the fuel electrode 27 of the DMFC stack 21 are returned to the mixing tank 20. Therefore, the high-concentration methanol is mixed with the water and the low-concentration methanol in the mixing tank 20 to be deluted, and a methanol aqueous solution having a predetermined concentration is produced.

The methanol aqueous solution produced in the mixing tank 20 is fed to the fuel electrode 27 of the DMFC stack 21 by the liquid feed pump 31. In the fuel electrode 27, methanol reacts with water to be oxidized, and hydrogen ions, carbon dioxide, and electrons are generated. The produced hydrogen ions pass through the electrolyte film 29 of the DMFC stack 21, and reach the air electrode 28.

The carbon dioxide which is produced in the fuel electrode 27 is led together with unreacted methanol aqueous solution to the first condenser 22, cooled by the cooling air blown by the first fan 50, and then returned to the mixing tank 20 via the fuel return pipe 32. The carbon dioxide which is returned to the mixing tank 20 vaporizes in the mixing tank 20, and flows into the exhaust pipe 43 via the branch pipe 48.

On the other hand, the air to be used in the generation of electricity is taken into the clean space 42 through the air intake filter 41 by driving the air feed pump 37. At this time, the air intake filter 41 catches dust in the air, and adsorbs hydrocarbon compounds contained in the air.

The air which is purified by the air intake filter 41 flows into the clean space 42. The air in the clean space 42 is drawn in through the air intake port 36, and fed to the air electrode 28 of the DMFC stack 21 via the air feed pump 37. In the air electrode 28, oxygen in the air is coupled with the hydrogen ions and electrons to be reduced, and water vapor is produced. At this time, electrons flow through an external circuit connected between the fuel electrode 27 and the air electrode 28, whereby the electricity generating operation is conducted.

The water vapor produced in the air electrode 28 flows into the exhaust pipe 43, and is led to the second condenser 23 while joining in the exhaust pipe 43 with the carbon dioxide from the mixing tank 20. In the second condenser 23, the water vapor is cooled by the cooling air blown by the second fan 51 to become water. The water is temporarily stored in the recovery tank 44. The gas from which water is separated, and which contains impurities such as carbon dioxide is discharged from the second condenser 23, and blown out together with the cooling air passing through the second condenser 23, from the discharge port 51a of the second fan 51 toward the exhaust port 52.

The water stored in the recovery tank 44 is fed into the mixing tank 20 via the recovery pump 46, and reused as water for diluting high-concentration methanol.

In the thus configured DMFC 1, air for electricity generation is purified by the air intake filter 41, and then drawn into the air intake port 36. Therefore, dust in the air, and hydrocarbon compounds which inhibit the reduction reaction on the air electrode 28 can be removed away on the upstream side the DMFC stack 21. Therefore, the electricity generation performance of the DMFC 1 can be maintained.

With elapse of the operation time of the DMFC 1, the air intake filter 41 is gradually contaminated, and it is inevitable that the purification performance is gradually lowered. In order to maintain the original electricity generation performance of the DMFC 1, therefore, maintenance of the air intake filter 41 must be frequently conducted to keep the original performance of purifying the air for electricity generation.

In the embodiment, the air intake filter 41 is supported by the partition wall 11d of the holder 10 so as to be exposed in the accessible compartment 16 (user accessible compartment) in which the fuel cartridge 13 is accommodated. Since the fuel cartridge 13 must be replaced with a new one each time when the fuel is exhausted, the fuel cartridge can be exposed together with the holder 10 to the outside of the device body 3, simply by detaching the cover 15.

Therefore, also the air intake filter 41 positioned in the accessible compartment 16 can be exposed to the outside of the device body 3, simply by detaching the cover 15, and operations of checking the degree of contamination of the filter, and attaching and detaching the filter to and from the holder 10 can be easily performed.

Consequently, operations of maintaining and replacing the air intake filter 41 can be easily performed without disassembling the device body 3, and do not require much labor. As a result, the air intake filter 41 can be always used in a state where it provides a high purification performance, and the electricity generation performance of the DMFC 1 can be satisfactorily maintained.

Furthermore, the air intake filter 41 stands along the partition wall 11d so as to be opposed to one end face of the fuel cartridge 13. Therefore, the air intake filter 41 can be enlarged in size, and a sufficient contact area with the air can be ensured. Consequently, the performance of adsorbing hydrocarbon compounds contained in the air can be particularly enhanced, and compounds hardly adhere to the air electrode 28. As a result, the electricity generation performance of the DMFC 1 can be prevented from being lowered, and a high output power can be obtained for a long term.

In the above-described configuration, the air intake filter 41, the air intake port 36, and the air feed pump 37 are linearly aligned from the upstream side to the downstream side along the flow direction of the air for electricity generation. Therefore, the pressure loss in the portion between the air intake filter 41 and the air feed pump 37 can be suppressed to the minimum, and the purification efficiency of the air intake filter 41 can be enhanced.

In accordance with the above, the air intake resistance in the operation of drawing in the air is reduced, and the load of the air feed pump 37 is lessened. Consequently, there is an advantage that the power consumption of the air feed pump 37 can be reduced.

As described above, according to the embodiment, the air intake filter can be exposed simply by detaching the cover, and hence operations of maintaining and replacing the air intake filter can be easily performed. Therefore, the air intake filter can be always used in a state where it provides a high purification performance, and the electricity generation performance of the fuel cell device can be satisfactorily maintained.

The present invention is not limited to the embodiment, and may be variously embodied without departing from the spirit and scope of the invention.

For example, the auxiliary unit which is attached to the holder is not limited to a fuel cartridge, and another component other than a fuel cartridge may be additionally attached to the holder.

The application of the fuel cell device of the invention is not limited to a portable computer. The fuel cell device may be applied as a power source for other electronic apparatus such as a PDA (personal digital assistant) device.

It is to be understood that the present invention is not limited to the specific embodiment described above and that the present invention can be embodied with the components modified without departing from the spirit and scope of the invention. The present invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A fuel cell device comprising:
a device body;
a fuel cell that is housed in the device body;
a user accessible compartment that is disposed in the device body and covered by a detachable cover;
an auxiliary unit that is disposed in the user accessible compartment;
an air intake port that is disposed in the user accessible compartment draws in air to be used in electricity generation by the fuel cell; and
a detachable air intake filter that covers the air intake port.

2. The fuel cell device according to claim 1, wherein the auxiliary unit includes a fuel cartridge that stores a fuel to be used in the electricity generation, and
wherein the fuel cell device further comprises a holder that is disposed in the user accessible compartment and detachably supports the fuel cartridge.

3. The fuel cell device according to claim 1, further comprising:
an air supply path that connects the air intake port and an air electrode of the fuel cell; and
an air feed pump that is provided in the air supply path and feeds air drawn in from the air intake port to the air electrode.

4. The fuel cell device according to claim 3, wherein the air intake filter and the air feed pump are linearly aligned.

5. The fuel cell device according to claim 1, wherein the air intake filter is exposed in the user accessible compartment, and adjacent to the auxiliary unit.

6. A fuel cell device comprising:
a device body having a closed compartment that houses a fuel cell and an accessible compartment that is covered by a detachable cover;
an air intake port that is disposed in the accessible compartment and draws in air to be used in electricity generation by the fuel cell; and
a detachable air intake filter that covers the air intake port and is disposed to be exposed in the accessible compartment.

7. The fuel cell device according to claim 6, further comprising:
an air supply path that connects the air intake port and an air electrode of the fuel cell; and
an air feed pump that is provided in the air supply path and feeds air drawn in from the air intake port to the air electrode,
wherein the air intake filter and the air feed pump are linearly aligned.

8. The fuel cell device according to claim 6, wherein the fuel cell device further comprises a fuel cartridge that is detachably supported in the accessible compartment to be disposed adjacent to the air intake filter in the accessible compartment.

9. A fuel cell device comprising:
a device body;
a fuel cell that is housed in the device body;
a user accessible compartment that is disposed in the device body and covered by a detachable cover;
an auxiliary unit that is disposed in the user accessible compartment;
an air exhaust port that exhausts a gas discharged from the fuel cell;
an air intake port that is disposed in the user accessible compartment to be opened in a direction different from the air exhaust port, and draws in air to be used in electricity generation by the fuel cell; and
a detachable air intake filter that covers the air intake port and is disposed to be exposed in the accessible compartment.

10. The fuel cell device according to claim 9, further comprising:
an air supply path that connects the air intake port and an air electrode of the fuel cell; and
an air feed pump that is provided in the air supply path and feeds air drawn in from the air intake port to the air electrode,
wherein the air intake filter and the air feed pump are linearly aligned.

11. The fuel cell device according to claim 10, wherein the fuel cell and the air feed pump are disposed between the air intake port and the air exhaust port.
